(19) United States
(12) Patent Application Publication
(10) Pub. No.: US 2015/0233421 A1
(43) Pub. Date: Aug. 20, 2015

(54) MAGNETIC RADIAL BEARING WITH A ROTOR LAMINATED IN A STAR-SHAPED MANNER

(71) Applicant: Siemens Aktiengesellschaft, München (DE)

(72) Inventors: Erich Bott, Hollstadt (DE); Rolf Vollmer, Gersfeld (DE)

(73) Assignee: Siemens Aktiengesellschaft, 80333 München (DE)

(21) Appl. No.: 14/366,476

(22) PCT Filed: Nov. 20, 2012
(86) PCT No.: PCT/EP2012/073044

§ 371 Date: Jun. 18, 2014

(30) Foreign Application Priority Data
Dec. 19, 2011 (EP) 11194329.6

(51) Int. Cl. F16C 32/04; F16C 41/00

(52) U.S. Cl. CPC F16C 32/0408; F16C 41/004

(57) ABSTRACT

The losses in a magnetic radial bearing are intended to be reduced. For this purpose, a magnetic radial bearing is provided with a stator and a rotor which is mounted rotatably in the stator, wherein the rotor has a shaft (7), the shaft (7) is surrounded by an annular laminate stack arrangement (5), and the laminate stack arrangement has individual laminates (6). The individual laminates (6) of the laminate stack arrangement (5) are arranged in a star-shaped manner with respect to the axis of the shaft (7).

The present invention relates to a magnetic radial bearing having a stator and a rotor which is rotatably mounted in the stator, wherein the rotor has a shaft, the shaft is surrounded by an annular laminate stack arrangement and the laminate stack arrangement has individual laminates.

In conventional magnetic radial bearings the stator has coils which are directed radially inwards with respect to the shaft to be mounted, i.e. the coils axes run substantially radially.

Radial magnetic bearings with axial coils are also known from the book “Magnetic Bearings” by Gerhard Schweitzer and Eric H. Masslen, Springer Verlag Berlin, 2009, XV, pages 82-94 and 96. This means that the coils axes extend parallel to the bearing axis. The flow in the coils and rotor is therefore conducted substantially in the axial direction.

Magnetic radial bearings must be able to adjust highly dynamic disturbance variables. The force should follow the current with an optimally short delay. Due to eddy currents in the rotor there is a time-dependent field displacement, and this leads to a frequency dependency of the bearing force. The eddy currents also lead to losses and heating of the rotor. Ultimately the efficiency of the machine is reduced hereby. To counteract this, a laminated, magnetic return is often provided on the shaft, and this reduces the eddy currents.

The pole numbers of the magnetic fields, the shaft rotational speed and the type of lamination are responsible for the eddy current losses. A low pole number is aimed at to achieve low magnetic reversal frequencies. As a result the magnetic field penetrates deep into the rotor, however, and therefore requires a lamination with high rotor yoke, and this then leads to a thin shaft. If critical oscillation tendencies are exceeded the pole number must be increased, and this again leads to higher frequencies and losses.

Magnetic radial bearings are known from U.S. Pat. No. 6,121,704 A and JP 11 101233 A which have a stator and a rotor with a shaft. The shaft is surrounded by an annular laminate arrangement, wherein the individual laminates of the laminate arrangement are arranged in a star-shaped manner with respect to the axis of the shaft. The individual laminates are I-shaped and connected together in the circumferential direction. The individual laminates are fastened to the shaft with a holding element and a fixing ring.

GB 2 246 401 A also describes a magnetic axial thrust bearing in which the stator and rotor have a plurality of individual laminates which are radially oriented with respect to the axis of a shaft. The individual laminates of the rotor are supported on a hub.

The object of the present invention is to provide a magnetic radial bearing in which the eddy currents are reduced further.

According to the invention this object is achieved by a magnetic radial bearing as claimed in claim 1. The radial bearing has a stator and a rotor which is rotatably mounted in the stator, wherein the rotor has a shaft, the shaft is surrounded by an annular laminate stack arrangement, and the laminate stack arrangement has individual laminates, wherein the individual laminates of the laminate stack arrangement are arranged in a star-shaped manner with respect to the axis of the shaft.

The rotor of the magnetic bearing therefore advantageously has individual laminates which, with respect to the rotor axis, project outwards in a star-shaped manner. Eddy currents in the tangential direction or in the circumferential direction can be greatly reduced thereby.

The laminate stack arrangement has a sleeve which is fastened to the shaft. The laminate stack arrangement may therefore be securely fastened to a shaft with just a few movements. The sleeve is formed by the individual laminates of the laminate stack arrangement itself in that the individual laminates are arranged annularly against each other accordingly.

Adjacent individual laminates of the laminate stack arrangement are connected together with integral fit. Adjacent individual laminates of the laminate stack arrangement can in particular be welded together. The individual laminates of the laminate stack arrangement can however also be soldered or glued together. A sleeve which is easy to assemble may be achieved with a connection of this kind with integral fit. Alternatively the adjacent individual laminates could also be connected together with interlocking fit.

The sleeve is advantageously shrunk onto the shaft. No additional components are required therefore to fasten the sleeve to the shaft. Shrinking-on also produces a very resistant connection.

There can be one wedge-shaped gap respectively between two adjacent individual laminates of the laminate stack arrangement. This is the case in particular if the individual laminates have a constant thickness in the radial direction with respect to the rotor axis.

In a special embodiment the individual laminates directly adjoin their adjacent individual laminates at the internal circumference of the laminate stack arrangement in each case. This gives the laminate stack arrangement an inner sheath without gaps. This also provides the tightest star-shaped laminations in the circumferential direction.

As mentioned above, there is optionally one wedge-shaped gap respectively between adjacent individual laminates of the laminate stack arrangement. This wedge-shaped gap is preferably filled by a non-conductive solid. This non-conductive solid serves to interrupt the flow of current in the circumferential direction of the rotor. In principle the wedge-shaped gap between the individual laminates does not have to be filled, but in this case the laminate stack arrangement is less stable and has a greater rolling resistance.

The solid for filling the wedge-shaped gap can be composed of a plastic, a glass or a ceramic. An epoxy resin or a low-melting glass is particularly suitable as the solid. The ceramic used may optionally also be sintered.

The present invention will now be explained in more detail with reference to the accompanying drawings, in which:

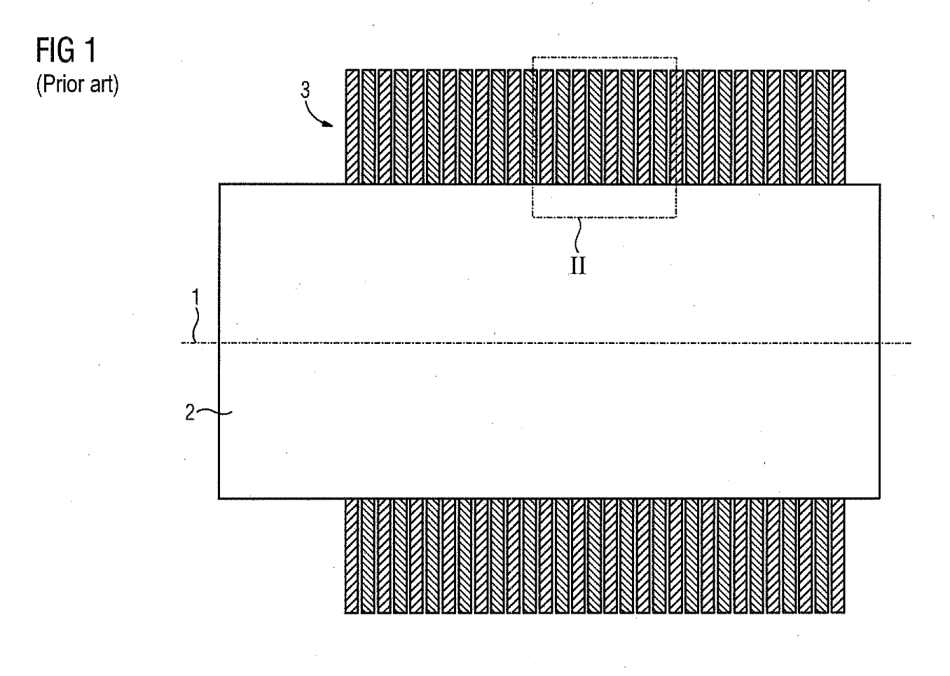

FIG. 1 shows a longitudinal section through the rotor of a magnetic radial bearing along the rotor axis;

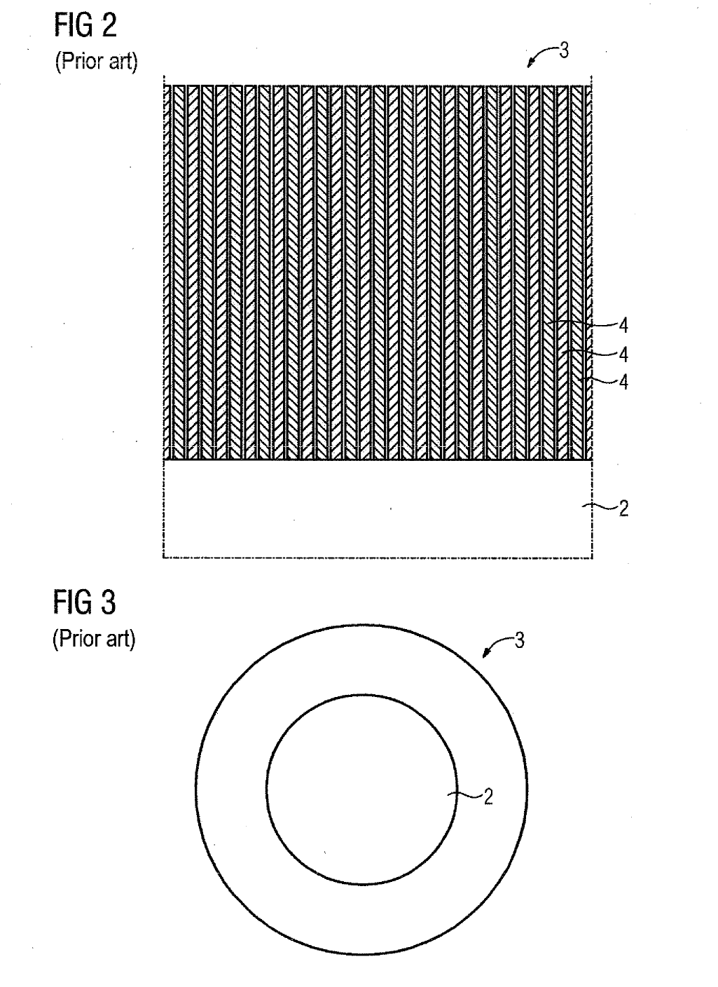

FIG. 2 shows an enlarged section of FIG. 1;

FIG. 3 shows an end face view of the rotor of FIG. 1;

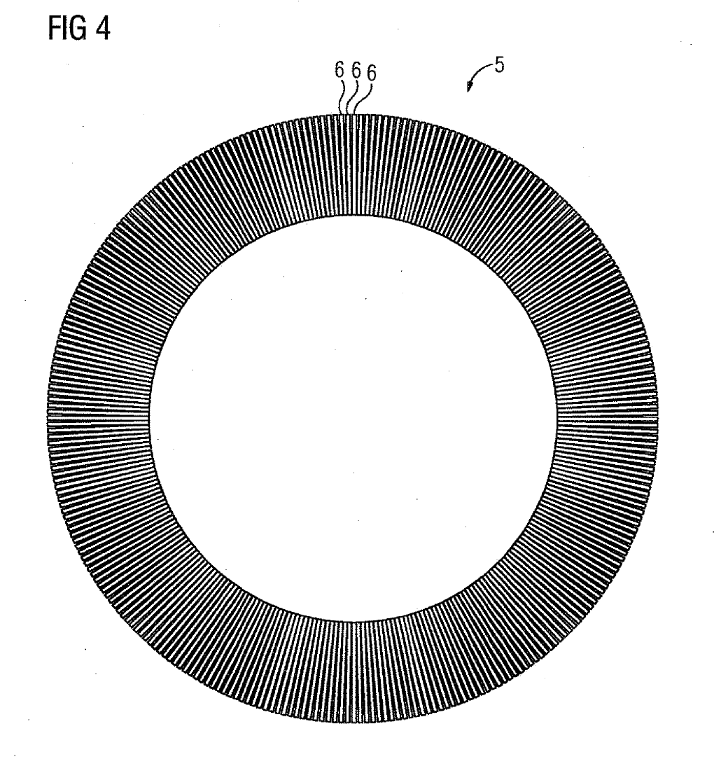

FIG. 4 shows an end face view of an inventive star-shaped laminate stack arrangement;

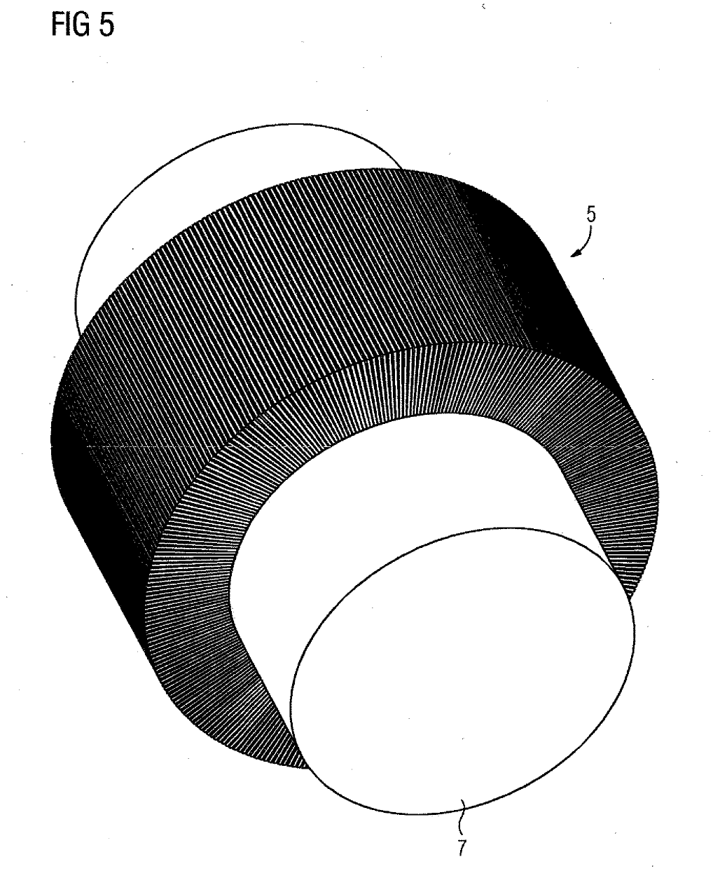

FIG. 5 shows the laminate stack arrangement of FIG. 4 on a shaft;

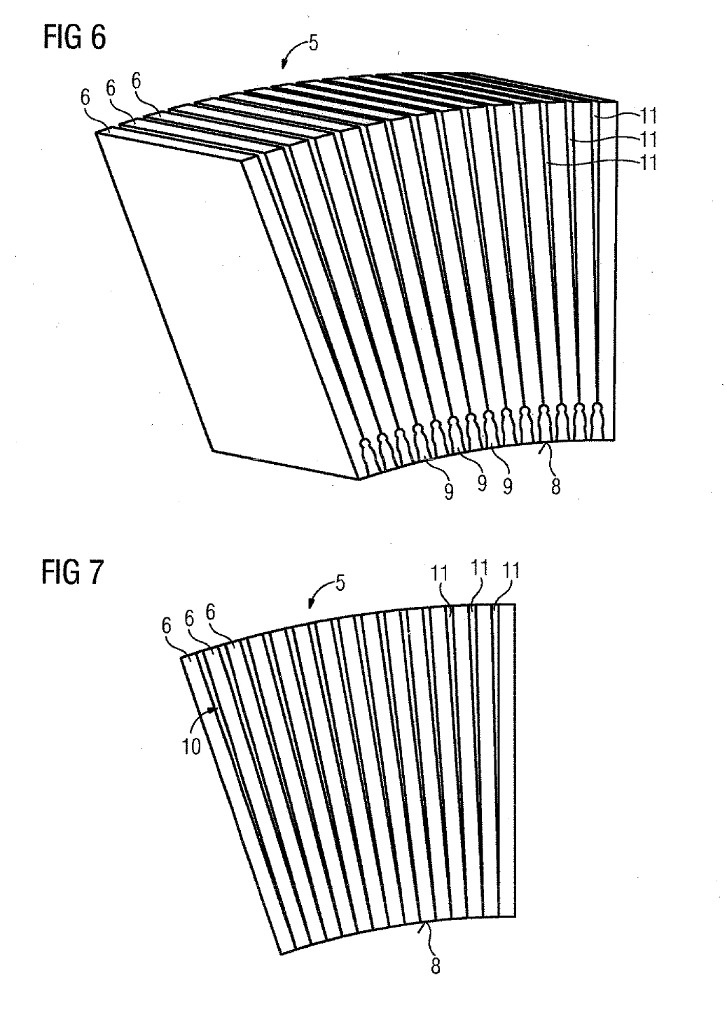

FIG. 6 shows an enlarged detail of the laminate stack arrangement of FIG. 4 in a perspective view, and

FIG. 7 shows the detail from FIG. 6 in an end face view.

The exemplary embodiments described in more detail below are preferred embodiments of the present invention.

For a better understanding of the invention, however, the prior art will first of all be described in more detail with reference to FIGS. 1 to 3.

A magnetic radial bearing has a stator and a rotor. The stator conventionally has a housing which has a hollow cylindrical construction. Located inside the housing, clinging to the housing wall, or at least recreating the housing wall, is a plurality of coils, preferably four coils. These coils are axial coils or radial coils. This means that the coil axes run either parallel to the bearing axis or perpendicular to it. Produced radially inside the coils is a free space in which the rotor can move freely. A rotor of this kind is illustrated in FIG. 1 in longitudinal section, i.e. in a section parallel to the axis of rotation 1 of the rotor.

The rotor reproduced in FIG. 1 has a cylindrical shaft 2. This is in part surrounded by a standard rotor laminate stack 3.

FIG. 2 reproduces an enlarged detail II in the region of the standard rotor laminate stack 3. The individual laminates 4 of the laminate stack, which are arranged on the shaft 2, can be seen here. The individual laminates 4 each extend primarily in a plane perpendicular to the axis of rotation 1 of the rotor. This means that the individual laminates 4 are stacked in the axial direction. Axial components of eddy currents can be effectively prevented thereby.

FIG. 3 shows the rotor of FIG. 1 in the end face view. The annular standard laminate stack arrangement 3 is provided on the shaft 2.

The laminate stack arrangement 3 illustrated with reference to FIGS. 1 to 3 is ineffective for an axial component of the magnetic flux, however, and increases the magnetic resistance in the axial direction. The efficiency of a magnetic radial bearing of this kind is sometimes limited therefore.

From the perspective of the rotor of a radial bearing there is an alternating magnetic field whose frequency is dependent on the stator pole number and speed. The stator pole number should be as low as possible. If possible the pole pair number 2 should therefore be chosen for the stator of the radial bearing. Currents are nonetheless induced in the electrically conductive regions of the rotor by changes in flux, and this requires special measures to reduce the eddy currents.

According to the invention a laminate stack arrangement is therefore provided for the rotor, the individual laminates of which project outwards radially or in a star-shaped manner. FIG. 4 reproduces a laminate stack arrangement of this kind in an end face view. The laminate stack arrangement 5 is annularly constructed here as in the example in FIGS. 1 to 3. In the specific example it has the figure of a hollow cylinder. It may also be called a star laminate sleeve since it has the function of a sleeve for the rotor and has star-shaped, outwardly projecting laminates. Each of the individual laminates 6 runs substantially in a plane parallel through the axis of the annular laminate stack arrangement 5.

FIG. 5 reproduces the laminate stack arrangement 5 in a perspective view. It is fastened to a shaft 7 here. The annular laminate stack arrangement 5 has an internal diameter which substantially corresponds to the external diameter of the shaft 7. The laminate stack arrangement 5 is preferably shrunk onto the shaft 7 of the rotor. For this purpose the laminate stack arrangement 5 has a slightly smaller internal diameter than the external diameter of the shaft 7.

FIG. 6 reproduces a detail of the laminate stack arrangement 5 of FIGS. 4 and 5 in a perspective view. The individual laminates 6 can clearly be seen there, and these protrude outwards in a star-shaped or radial manner. All of the individual laminates 6 have the same thickness. As a result of the fact that they project outwards in a star-shaped manner, one wedge-shaped gap 11 respectively results between two adjacent individual laminates 6. This wedge-shaped gap tapers in the direction radially with respect to the center of the laminate stack arrangement 5. The cross-section of the gap 11 does not change in the axial direction.

The individual laminates 6 rest directly on each other at the inner sheath 8, i.e. there is no gap between the individual laminates 6 at the inner sheath 8. They are therefore preferably fastened to each other at this location.

In the example of FIG. 6 the individual laminates 6 are connected together with integral fit. Specifically they are welded together. This is indicated in FIG. 6 by weld zones 9. These weld zones 9 are produced by way of example by arc welding. They run over a certain radial distance. The center of each individual weld zone 9 is always the region in which two adjacent individual laminates 6 adjoin each other. In a predefined radial section the individual laminates 6 are permanently joined together by the welding and they gape apart further and further the greater the distance is from the inner sheath 8.

FIG. 7 illustrates the laminate stack section of FIG. 6 in the end face view. In this perspective the individual laminates 6, which project outwards radially or in a star-shaped manner from the inner sheath 8 of the annular laminate stack arrangement 5, and the wedge-shaped gaps 11 between the individual laminates 6 can be seen. The gaps 11 are not filled with air here, but it is graphically shown in FIG. 7 that the gaps 11 are filled with a filler 10. This filler 10 should be an electrically non-conductive, organic or inorganic solid. Epoxy resin is particularly suitable as the filler 10. Alternatively a low-melting glass or a ceramic may be used for filling. The ceramic is optionally sintered into the gap 11, so a corresponding integral fit results.

Filling the gaps 11 has advantages in particular at high rotational speeds. Filling increases the strength of the laminate stack arrangement in addition to reducing the air resistance (fewer air eddies occur at the external circumference of the annular laminate stack arrangement).

The star-shaped, laminated sleeve therefore constitutes a component which can be easily provided on the shaft of a magnetic radial bearing and provides here for reduced eddy currents in the circumferential direction. Reduced magnetic resistance in the axial direction also results thereby.

What is claimed is:

1.-7. (canceled)

8. A magnetic radial bearing, comprising:
a stator; and
a rotor rotatably mounted in the stator, said rotor having a shaft and an annular laminate stack arrangement in surrounding relationship to the shaft, said laminate stack arrangement having individual laminates arranged in a star-shaped manner with respect to an axis of the shaft and configured to form a sleeve which is fastened to the shaft, wherein adjacent individual laminates of the laminate stack arrangement are connected together with integral fit.

9. The magnetic radial bearing of claim 8, wherein the sleeve is shrunk onto the shaft.

10. The magnetic radial bearing of claim 8, wherein adjacent individual laminates of the laminate stack arrangement define a wedge-shaped gap there between.

11. The magnetic radial bearing of claim 8, wherein each of the individual laminates directly adjoins an adjacent one of the individual laminates at an internal circumference of the laminate stack arrangement.

12. The magnetic radial bearing of claim 8, wherein adjacent individual laminates of the laminate stack arrangement are welded together.

13. The magnetic radial bearing of claim 10, further comprising a non-conductive solid adapted to fill the wedge-shaped gap.

14. The magnetic radial bearing of claim 13, wherein the solid is composed of a plastic, a glass or a ceramic.
